(19) United States
(12) Patent Application Publication
(10) Pub. No.: US 2008/0109433 A1
(43) Pub. Date: May 8, 2008

(54) Internet-based real estate searching system and process

(76) Inventor: Norvell S. Rose, Virginia Beach, VA (US)

Correspondence Address: STEPHEN E. CLARK, P. O. BOX 11294, NORFOLK, VA, 23517, US

(21) Appl. No.: 11/982,919

(22) Filed: Nov. 6, 2007

Related U.S. Application Data
(60) Provisional application No. 60/857,068, filed on Nov. 6, 2006.

(51) Int. Cl. G06F 17/30

(52) U.S. Cl. 707/6; 707/E17.108

(57) ABSTRACT

An internet-based real estate searching process dynamically serves and delivers relevant contextual content to the user. In a preferred embodiment, the process includes the steps of obtaining user profile information, presenting a real estate search interface to a searching user, obtaining search criteria from the searching user, searching a real estate data base using the search criteria, returning search results, obtaining a property selection from among said search results, and running coordinated video and audio information relevant to the property selection. Targeted ads are run based on matching characteristics of the target market segment to the user's profile. The user's profile is modified and updated based on tracking of the users selections of advertisements and searched properties

### RELATED APPLICATION

This application is a Utility Patent application based on a previously filed U.S. Provisional Patent application, U.S. Ser. No. 60/857,068 filed on Nov. 6, 2006, the benefit of the filing date of which is hereby claimed under 35 U.S.C. .sctn. 119(e).

### BACKGROUND OF THE INVENTION

1. Field of the Invention

The present invention relates to the field of information searching and browsing. More particularly, the present invention relates to Internet-based systems and methods for enhancing real estate and related commerce searching activities through interaction with a personalized relevance interface.

2. Description of the Prior Art

Traditionally, a seller of real estate retains a real estate agent to help sell the property. In the United States, the real estate agent typically advertises the property and is paid a percentage of the final sale price of the home upon sale. The predominant real estate advertising service in the United States is known as the Multiple Listing Service, or the “MLS”. Real estate agents and buyers examine MLS listings to see what is available on the market. After narrowing their choices, actual home visits are arranged. The time consuming nature of actual visits limits the number of potential houses that can be viewed by a potential buyer.

With the widespread use of the Internet, more and more home owners are advertising on the Internet. Recently, Internet advertising has developed more sophisticated features.

Unlike traditional MLS listings, which typically featured only one still image of the home, Internet advertising allows multiple photographic images of the real estate property on sale. Additionally, some listings enable the potential buyer to take “virtual tours” of the property through multiple photos, panoramic images, and 360 degree images of the homes. Virtual tours give the potential buyer a better sense of the property without having to spend the time required to actually visit individual homes. The buyer virtually sees and visits the real estate property at the comfort of his or her computer.

A typical real estate transaction involves numerous parties, including buyers and sellers, real estate brokers and agents, lenders and mortgage brokers, insurance companies and agents, home inspectors, settlement attorneys and title companies. In addition to these parties, each of whom may be directly involved in the real estate transferal process, many other ancillary businesses and services are, or may be, of interest to persons who purchase, or who contemplate purchasing, real estate. Such ancillary businesses and services might include, for example, local hardware stores, landscaping services, schools, furniture movers, grocery stores, and other vendors.

With respect to prior Internet-based real estate searching platforms, a potential property buyer would typically start at a sponsored Website's home page. At the home page, the potential property buyer would typically select various property-characteristic preferences from a list. Such preferences might include, for example, location, price range and/or the number of bedrooms of a sought house. A listing of the search results would then typically be displayed. The user may then typically select (i.e., “click on”) a property of interest from the search list. This would typically cause detailed information to be displayed about the selected property. With some prior platforms, if the user wants further information on the property, the user may be able to click on a “hot button”, thereby providing a notification of interest that can be emailed to a listing agent or to the property owner. In some cases, the notification of interest is pre-formatted and automatically sent; and, in other cases, the user is able to insert his/her questions or comments into an email notice.

The above-described type of prior Internet-based real estate searching platform may, of course, be hosted by various entities (the “Platform Provider”), including real estate agencies/agents, themselves, as well as by others. When the Platform Provider is neither a real estate agency nor a real estate agent, income revenues are typically generated for the Platform Provider by sponsored Website advertisements and/or by charging real estate agents/agencies for listing their properties. Such sponsored Website advertisements may be displayed on any of the screens of the platform.

A problem with such prior Internet-based real estate searching systems and methods is that the amount that advertisers typically are charged by the Platform Provider for any particular displayed advertisement cannot be readily adjusted based on a continuous reporting of whether the platform's users notice, or actually pay attention to, or indicate any interest in, the particular advertisement.

Another problem with such prior Internet-based real estate searching systems and methods is that, for any given Webpage, the content of the advertisements that are displayed are largely independent of the full content of the displayed screen. Under prior systems and methods, an advertisement for, say, an outdoor pool supplier that sponsors, for example, a search list screen of a particular platform will be displayed whenever that screen is pulled up, regardless of whether the user is looking for (and the search list presents) any properties that could possibly accommodate an outdoor pool.

Another problem with such prior Internet-based real estate searching systems and methods is that, for any given screen of the Website, the content of the advertisements that are displayed are largely independent of the geographic location of the searched real estate. For example, under prior systems and methods, a national retailer that sponsors, say, a the Website's individual property display screen, typically displays the same advertisement whenever that sponsored screen appears, even if the sponsoring retailer has no outlets in the vicinity of the searched real estate.

Another problem with such prior Internet-based real estate searching systems and methods is that, for the advertisements that are displayed on any given screen of the Website, the content of the advertisements that are displayed are not targeted based on the behavioral, cultural, social, or economic demographics of the user. For example, under prior real estate searching systems and methods, a playground equipment vendor that sponsors, say, the individual property display screen of a prior platform, would typically be required to pay to display, say, the same (playground equipment) advertisement whenever the sponsored screen appears, even if the user happens to be looking for (and the screen only shows) an assisted care retirement condominium where such playground equipment would be wholly inappropriate.

Another problem with such prior Internet-based real estate searching systems and methods is that even those platforms that supplement written information about selected properties with photographs, including those that reportedly show “panoramic views”, typically use only still photographic shots. In some instances the image portrayed on the screen may appear to move, but “movement” is typically no more than changes in the displayed portion of a still image. Thus, such prior systems do not provide for showing of true motion videos of a selected property.

Another problem with such prior Internet-based real estate searching systems and methods is that even those that supplement written information about selected properties with video images, typically do not include audio streaming in coordination with the selected properties. Thus, such prior systems do not provide for presenting coordinated textual, video and audio information about a selected property.

Another problem with such prior Internet-based real estate searching systems and methods is that they lack captology capabilities whereby the Platform Provider can keep track of, for example, the number of times individual sponsored links are selected (i.e., clicked on). Thus, such prior systems do not provide for a practical means by which the Platform Provider can charge advertisers only on a fee-per-hit basis.

Another problem with such prior Internet-based real estate searching systems and methods is that they lack real-time reporting measurement capabilities. Thus, such prior systems do not provide for a practical means by which a Platform Provider or an advertiser can track user interest in a particular property in real time.

There is, then, a need in the art for an Internet-based real estate searching system and method that dynamically serves and delivers relevant contextual content to the user.

### SUMMARY OF THE INVENTION

In view of the foregoing disadvantages inherent in the known real estate searching systems and methods now present in the prior art, the present invention provides an Internet-based real estate searching system and method that dynamically serves and delivers relevant contextual content to the user.

It is an object of the present invention to provide a searching system and method of the character described that includes reporting means by which a System Provider may accurately track, and bill an advertiser based on the degree of, user interest in displayed advertisements.

It is an object of the present invention to provide a searching system and method of the character described having means for constructing a user profile for each user of the system, for determining whether the user profile of a system user corresponds to predetermined characteristics of a predetermined target market segment, and for displaying targeted advertisements when the user's profile corresponds to the predetermined characteristics of the predetermined target market segment.

It is another object of the present invention to provide a searching system and method of the character described wherein the content of the advertisements that are displayed may be dependent on, and readily varied in accordance with, the context of the displayed screen.

It is another object of the present invention to provide a searching system and method of the character described wherein, for any given screen, the content of the advertisements that are displayed can be user-targeted based on, and readily varied in accordance with, the geographic location of the searched real estate.

It is another object of the present invention to provide a searching system and method of the character described wherein advertisements that are displayed on any given screen can be targeted and readily varied based on the behavioral, cultural, social, economic or other demographic characteristics of the user.

It is another object of the present invention to provide a searching system and method of the character described wherein written information about a selected property is complemented by true motion videos of a searched and selected property.

It is another object of the present invention to provide a searching system and method of the character described that provides for presenting coordinated textual, video and audio information about a selected property.

It is another object of the present invention to provide a searching system and method of the character described that includes captology means by which the System Provider can keep track of, for example, the number of times each individual sponsored links are selected (i.e., clicked on), thus providing for a practical means by which the System Provider can charge advertisers only on a fee-per-hit basis.

It is another object of the present invention to provide a searching system and method of the character described that includes real-time reporting measurement capabilities, thus providing for a practical means by which a System Provider or an advertiser can track user interest in real time.

In these respects, the Internet-based real estate searching system and method according to the present invention substantially departs from the conventional concepts and designs of the prior art.

These, together with other objects of the invention, along with the various features of novelty that characterize the invention, are pointed out with particularity in the claims annexed to and forming a part of this disclosures. For a better understanding of the invention, its operating advantages and the specific objects attained by its uses, reference should be made to the accompanying drawings and descriptive matter in which there are illustrated a preferred embodiment of the invention and variations thereof.

### BRIEF DESCRIPTION OF THE DRAWINGS

A preferred embodiment of the present invention has been depicted for illustrative purposes wherein:

FIG. 1 is a simplified, semi-schematic, screen shot, depicting the search interface home page that is presented to the searching user in a preferred embodiment of the invention;

FIG. 2 is a simplified, semi-schematic, screen shot, similar to FIG. 1, highlighting the Content Section Tabs presented to the searching user in a preferred embodiment of the invention;

FIG. 3 is a simplified, semi-schematic, screen shot, similar to FIG. 1, highlighting the “Go Local” drop-down menu presented to the searching user in a preferred embodiment of the invention;

FIG. 4 is a simplified, semi-schematic, screen shot, similar to FIG. 1, highlighting the “National” tab presented to the searching user in a preferred embodiment of the invention;

FIG. 5 is a simplified, semi-schematic, screen shot, similar to FIG. 1, highlighting the “Ad Unit” displays presented to the searching user in a preferred embodiment of the invention;

FIG. 6 is a simplified, semi-schematic, screen shot, similar to FIG. 1, highlighting the Slide-Out display area presented to the searching user in a preferred embodiment of the invention;

FIG. 7 is a simplified, semi-schematic, screen shot, similar to FIG. 1, highlighting the “adjacent content area” display presented to the searching user in a preferred embodiment of the invention;

FIG. 8 is a simplified, semi-schematic, screen shot, similar to FIG. 1, highlighting the sub-division display areas of the “adjacent content area” presented to the searching user in a preferred embodiment of the invention;

FIG. 9 is a simplified, semi-schematic, screen shot, similar to FIG. 1, highlighting the “Content Section Playlist” area presented to the searching user in a preferred embodiment of the invention;

FIG. 10 is a simplified, semi-schematic, screen shot, similar to FIG. 1, highlighting the sub-division display areas of the “Content Section Playlist” presented to the searching user in a preferred embodiment of the invention;

FIG. 11 is a simplified, semi-schematic, screen shot, similar to FIG. 1, highlighting the “Main Media” display area and “Player Control” area presented to the searching user in a preferred embodiment of the invention;

FIG. 12 is a simplified, semi-schematic, screen shot, similar to FIG. 1, highlighting the “Relationship/Feedback” buttons presented to the searching user in a preferred embodiment of the invention;

FIG. 13 is a simplified, semi-schematic, screen shot, similar to FIG. 1, highlighting the “My Account” button presented to the searching user in a preferred embodiment of the invention;

FIG. 14 is a simplified, semi-schematic, screen shot, similar to FIG. 1, highlighting the “Interactive Overlay Icon” display area presented to the searching user in a preferred embodiment of the invention;

FIG. 15 is a schematic diagram that illustrates a general hardware environment that may be utilized to implement an embodiment of the invention; and,

FIG. 16 is a flow diagram that illustrates a preferred method of the present invention.

### REFERENCE NUMERALS IN DRAWINGS

10 Graphical User Interface, general
12 Content Section Tabs
12a Hot Property Tab
12b Hot Agent Tab
12c New Communities Tab
14a Ad unit display
14a Ad unit display area, small
14b Key Sponsor Ad unit display area
16 Playlist for main media display
16a Photograph display area
16b Text display area
16c Scroll bar
18 Main media content area
20 Main media adjacent content area
20a Text area
20b Text area
20c Photograph area
20d Link area
22 “Relationship/Feedback” buttons
22a “Map” button
22b “Track” button
22c “Rate” button
22d “Email to a Friend” button
22e “Save” button
24 “My Account” button
25 Interactive Overlay Icon
28 “Go Local” button
30 “National” button
32 Slide Out display
34 MLS button
40 Player control panel
40 a Play Button
40 b Chapter Back Button
40c Pause Button
40 d Chapter Forward Button
40 e Audio on/off buttons
40 f Player Timer
40 g Playhead
101 National Page GUI
102 Sponsored Property Page GUI
103 Local Page GUI
160 Playlist item display
600 Computer
610 Keyboard
611 Mouse
612 Mass Storage
613 Processor
614 Video Memory
615 Main Memory
616 Video amplifier
617 Monitor
618 Bi-directional system bus
619 Input/output device
620 Communication interface
621 Network link
622 Local network
623 Server
624 ISP
625 Internet
626 Server
627 Audio memory
628 Audio Speaker
801-816 Process steps

### DESCRIPTION OF THE PREFERRED EMBODIMENT

Described below are details of a preferred embodiment of an Internet-based real estate searching system and method that dynamically serves and delivers relevant contextual content to the user.

As the present invention may be embodied in several forms without departing from the spirit or essential characteristics thereof, it should also be understood that the description contained herein is not limited by the details of the foregoing description, unless otherwise stated. The present invention should be construed within its spirit and scope, and therefore all changes and modifications that fall within the metes and bounds of the claims, or equivalences of such metes and bounds are therefore intended to be embraced by the invention.

### Preferred Embodiment of the Graphical User Interface

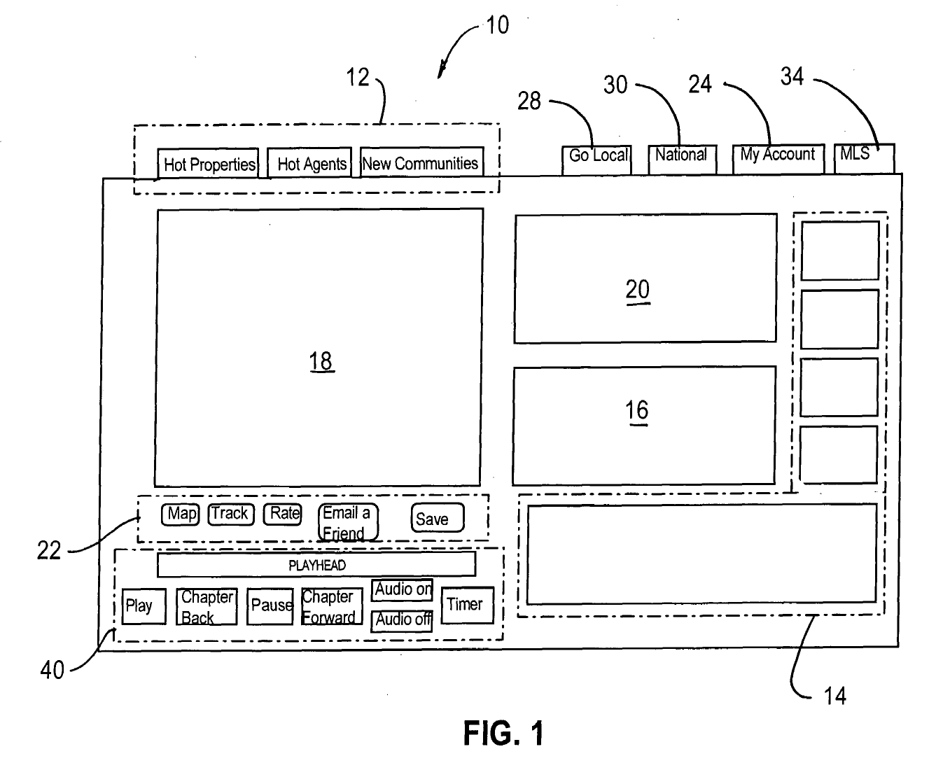

FIG. 1 shows a preferred graphical user interface (“GUI”), generally designated 10, illustrating the home page of a website that exemplifies the form and function of the present invention.

The GUI 10 comprises several general areas, including content section tabs 12, ad unit displays 14, playlist for main media display 16, main media content area 18, main media adjacent content area 20, relationship/feedback buttons 22, “my account” 24, and interactive overlay icons 26.

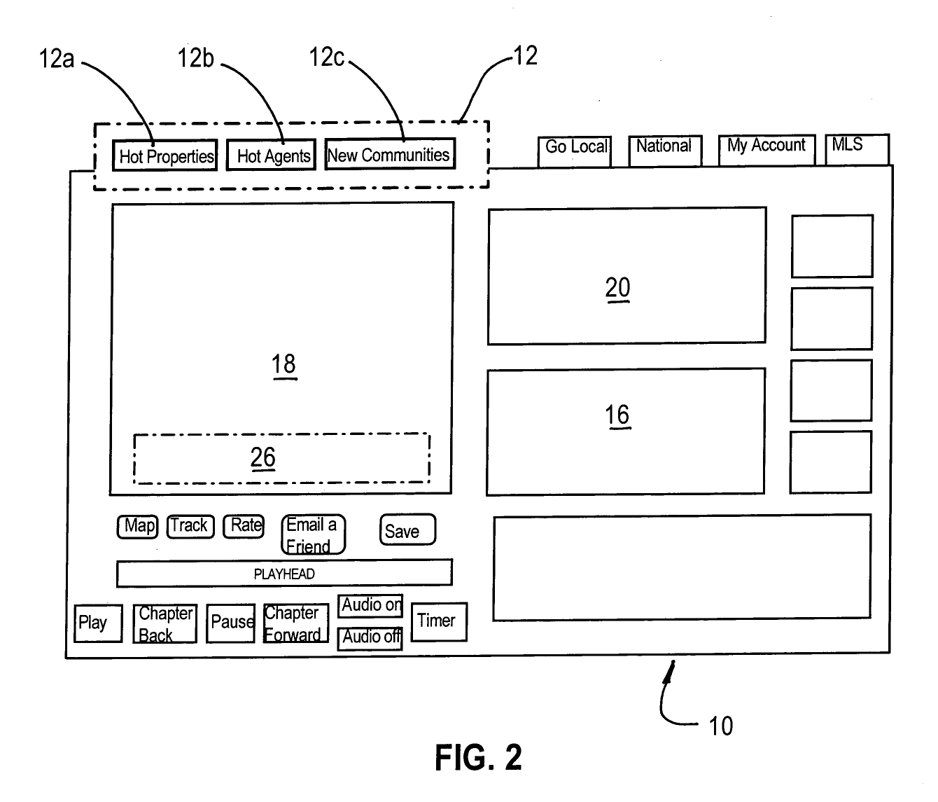

Referring to FIGS. 1 and 2: The content section tabs 12 are the gateway to the different content areas offered. When the user selects (i.e., “clicks on”) an individual content section tab 12a, 12b, 12c, 12d, the selected tab lifts up higher than the rest of the tabs to indicate the section that the user has selected. In addition, when the user clicks on an individual content section tab 12a, 12b, 12c, 12d, the respective advertising (including the small partner ad units 14a and the key sponsor ad unit 14b), playlist 16, adjacent content 20 and main media display 18 for the identified MSL area will load.

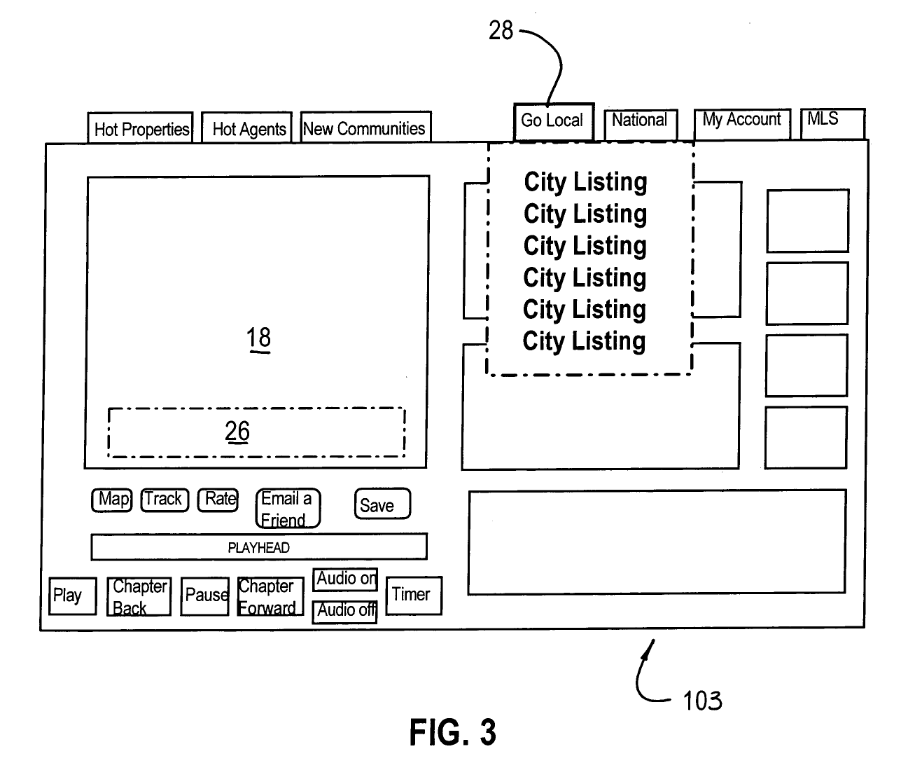

Referring to FIGS. 1 and 3: The “Go Local” (or, alternatively, “go regional”) tab 28 launches a list of cities/MLS areas that are represented by the System Provider.

When a user clicks on the Go Local tab 28, the city listing will appear, either as a pull down list or as a pop up screen. From the city listing, the user may choose a specific city in which to conduct a property search. In the preferred embodiment of the invention, the city names will be pulled directly from current MLS data. Each city listed is clickable.

When the user clicks on a city, the player will default to the System Provider's content and begin populating the content areas with the local content of the selected (i.e., clicked on) city.

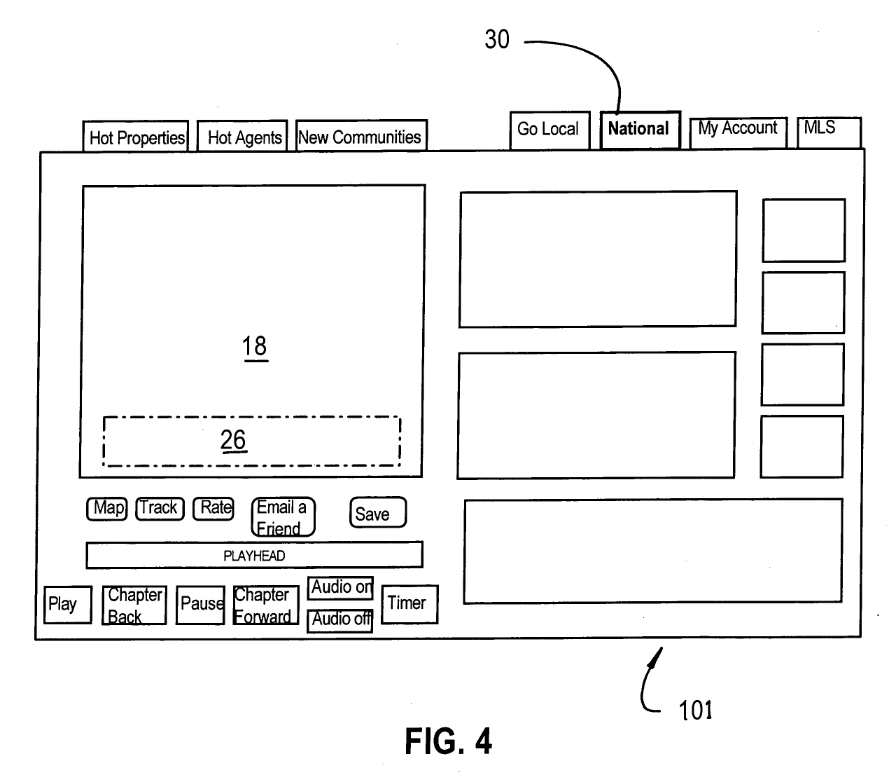

Referring to FIGS. 1 and 4: The National Tab 30 populates the player with the National content.

When the user clicks on the National Tab 30, the player will DEFAULT to the System Provider's content and begin populating the content areas with the national content.

When on the national player, the National Tab 30 lifts up higher than the rest of the Tabs (i.e., Go Local tab 28 and My Account tab 24) to indicate that the section has been selected.

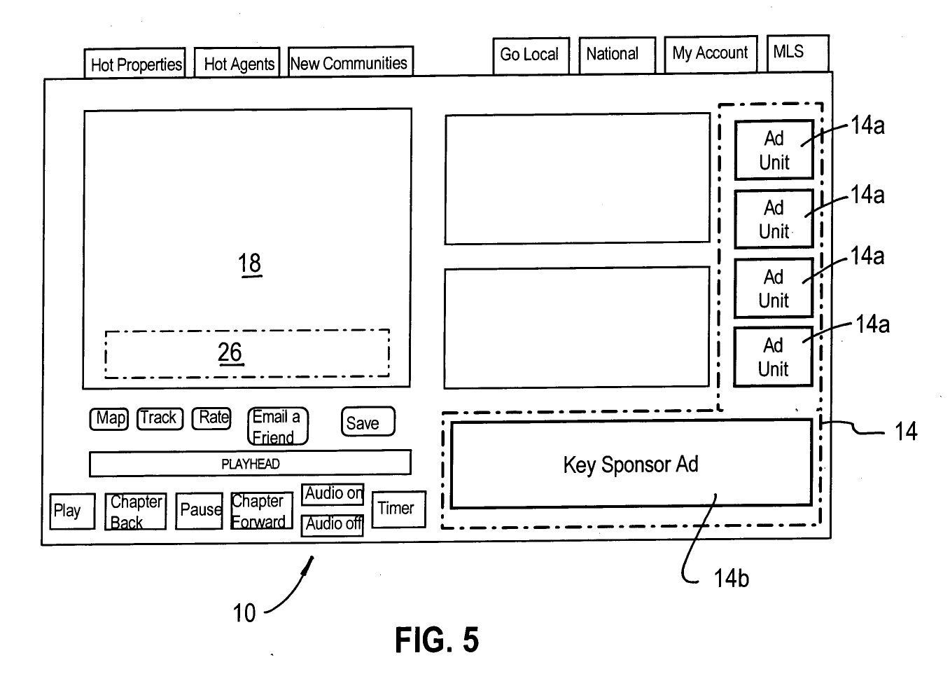

Referring to FIGS. 1 and 5: The ad units 14a, 14b display content based on the subject of the main media display 18.

The ad units 14a, 14b to be displayed will be pre-determined based on a set of criteria, as described more fully herein below. Each individual ad unit 14a, 14b has the capability to rotate based on as set time, rather than wait for a page to refresh.

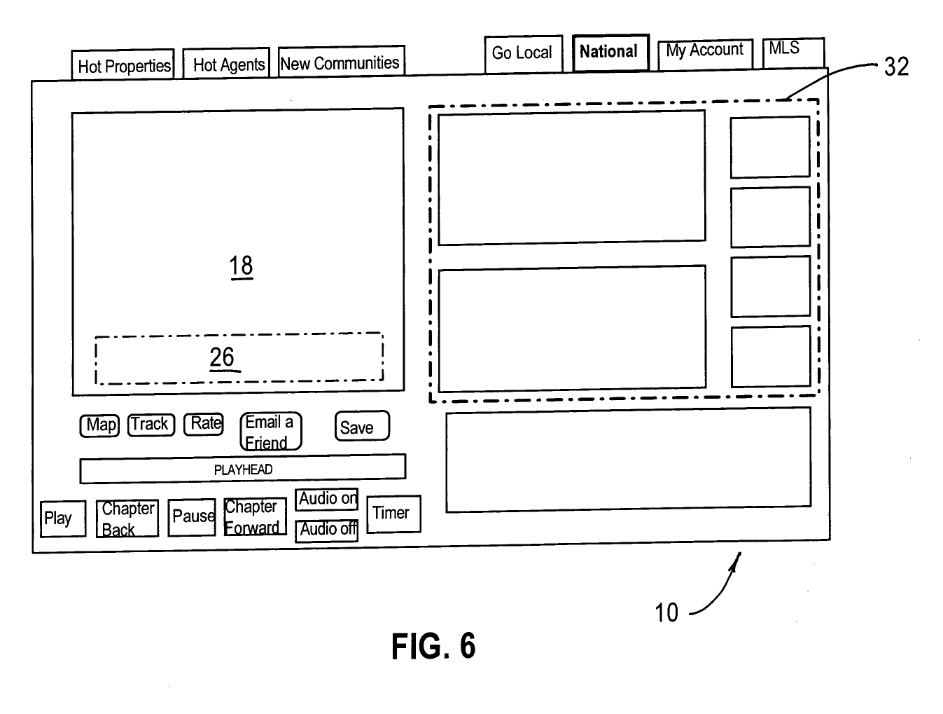

When an individual ad unit 14a, 14b is clicked on, it initiates either a pop-up window that launches the respective URL, or a “slide out display” 32 that shows a video, jpeg or swf., as illustrated in FIG. 6.

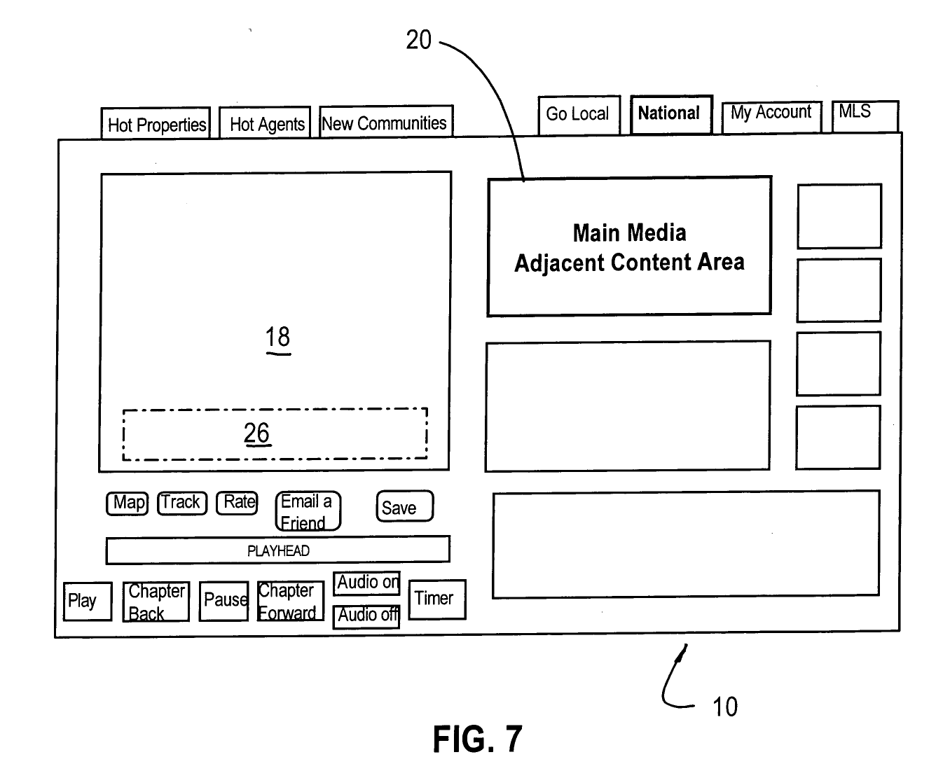

Referring to FIGS. 1, 7 and 8: The main media adjacent content area 20 displays detail information relating to the content that is currently showing in the main media display 18.

For example, if the main media display is showing a “hot property”, then the main media adjacent content area 20 may display agent information pertaining to that property's listing agent.

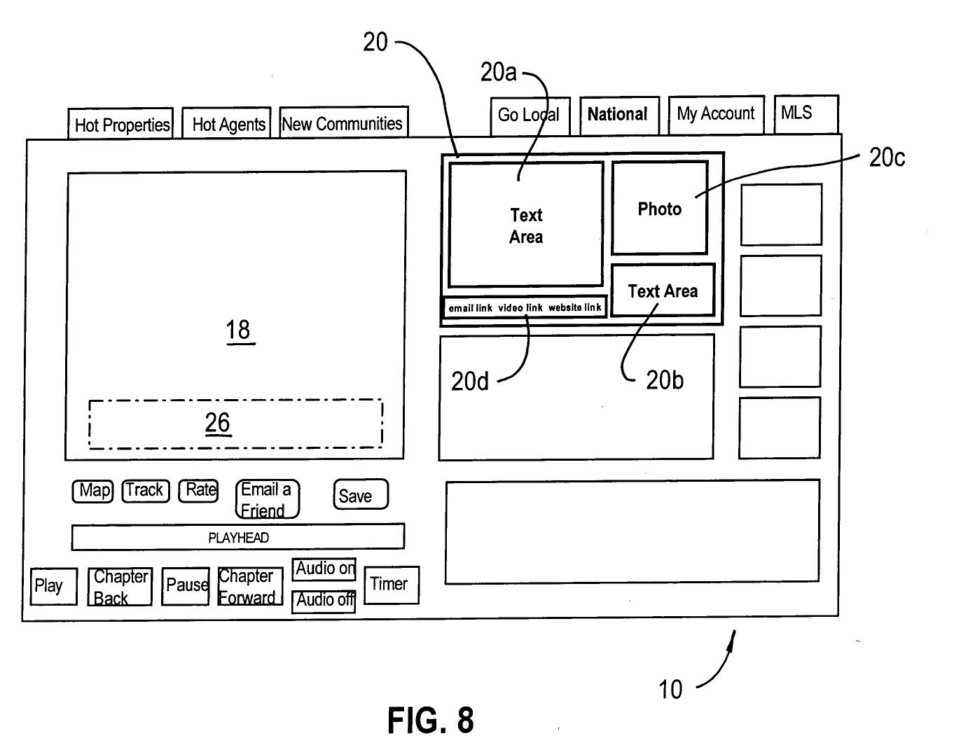

As illustrated in FIG. 8, in the preferred embodiment of the invention, the main media adjacent content area 20 is subdivided into descriptive text area(s) 20a, 20b, photograph area(s) 20c, and/or areas for links 20d to email or other websites.

The main media adjacent content area 20 is initiated from the content in the main media display 18. The information displayed in the main media adjacent content area 20 is, in the preferred embodiment of the invention, static, and is populated via the administration console. When the user clicks on the “email” link, the user's email program is opened, and the Agent's email address is pre-filled in; when the user clicks on the “website” link, a new window (preferably the Agent's website URL) pops open; and, when the user clicks on the “video” link, the Agent's personal video is launched in the Slide Out Display 32, as illustrated in FIG. 6.

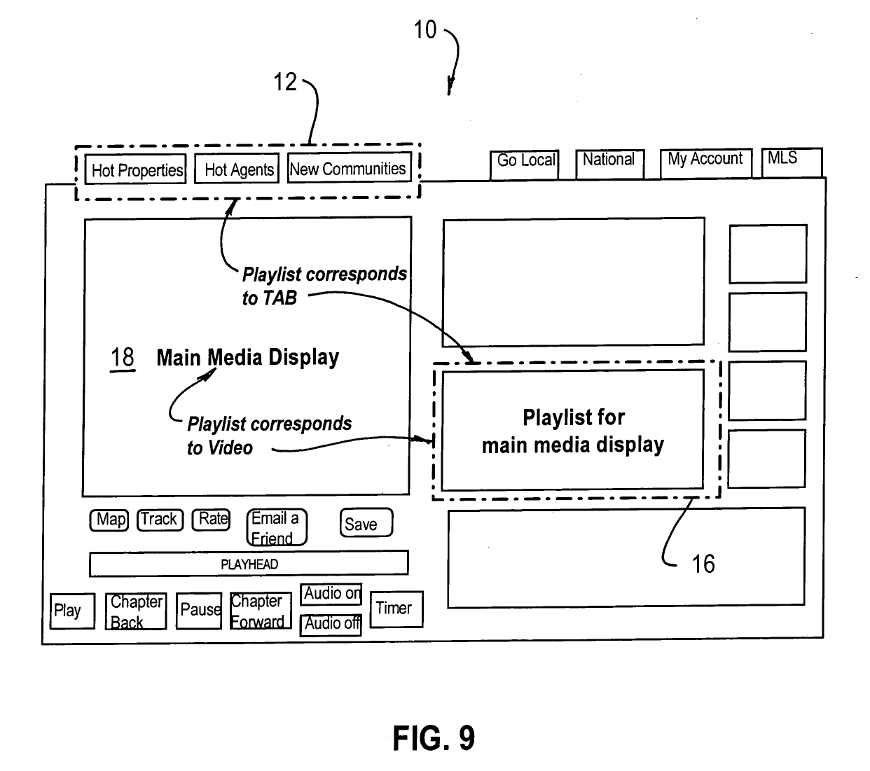

Referring to FIGS. 1, 9 and 10: The Main Media Display Playlist Area 16 displays a playlist corresponding to the particular Content Section Tab 12a, 12b, 12c that is selected.

For example, if the “Hot Property” Tab 12a is clicked on, then the playlist of the “hot properties” will appear in the playlist display area 16.

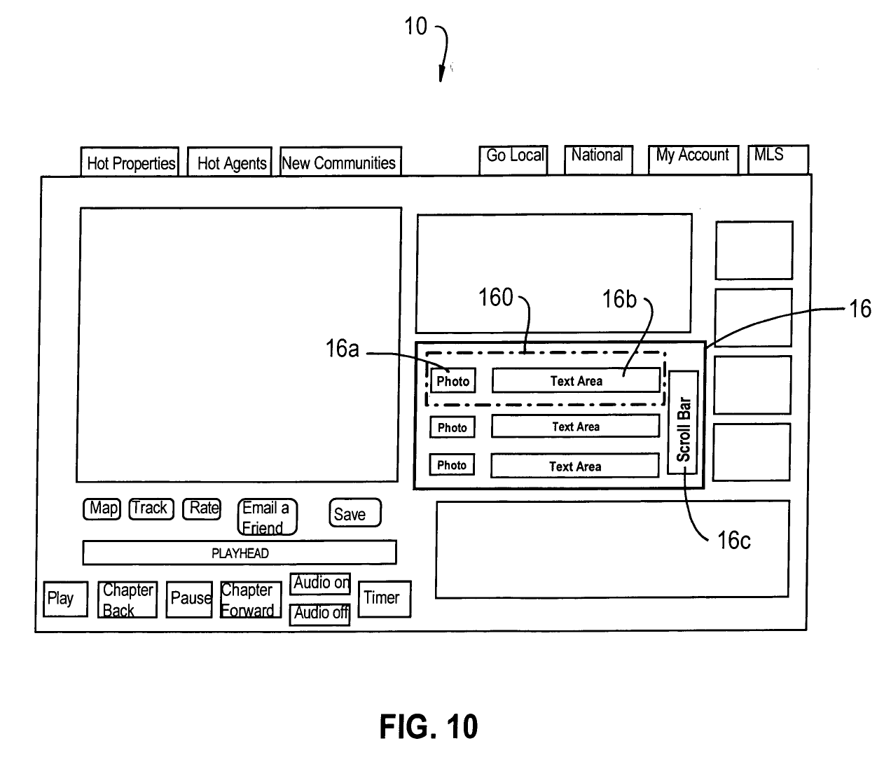

As illustrated in FIG. 10, in the preferred embodiment of the invention, the playlist display area 16 is subdivided into descriptive text area(s) 16a, photograph area(s) 16b, and may additionally include a scroll bar 16c, if needed.

Each playlist item 160 preferably comprises a photograph (i.e., at 16a) and descriptive text (i.e., at 16b). The photograph area 16a and text area 16b for each playlist item 160 links to the media player. The playlist area 16 will be populated by the administration console. When a playlist item 160 is selected (i.e., clicked on), the main media display 18 begins playing corresponding video (and, optionally, corresponding audio).

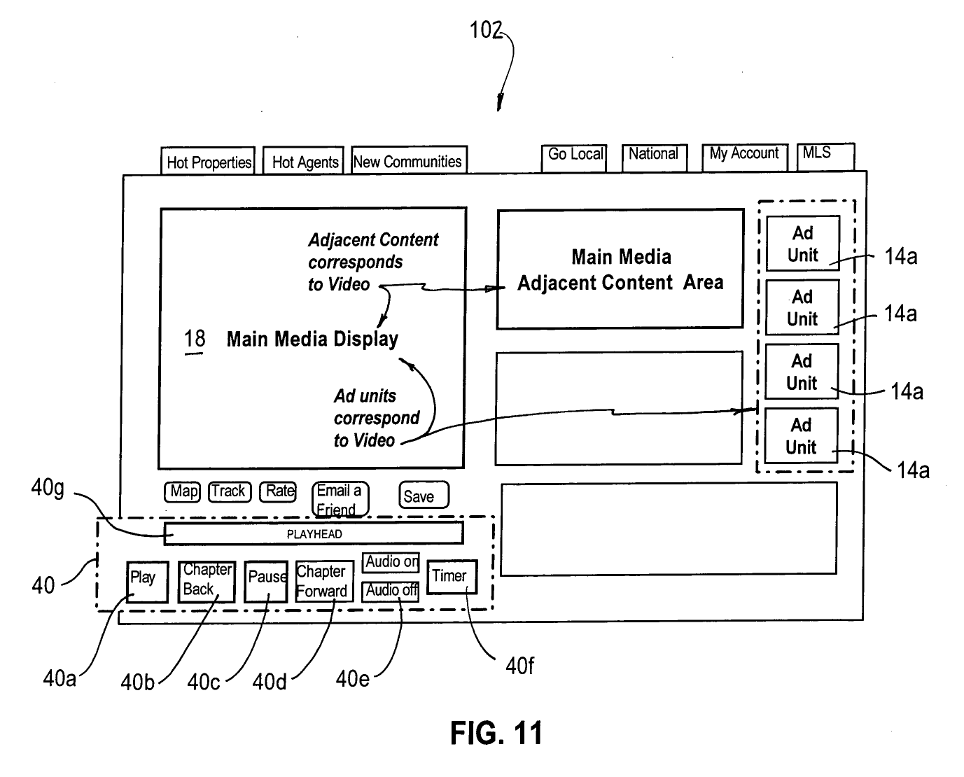

Referring to FIGS. 1 and 11: The main media display 18 is the focal point of the website's GUI 10. The content of the main media display 18 is initiated from, and is coordinated with, the selected (i.e., clicked on) playlist item(s) 160. The the main media display 18 is capable of playing videos, jpeg's, swfs and MP3s.

In the preferred embodiment of the invention, while content is being loaded onto the player (i.e., before the content is displayed/played), “Buffering” graphic displays, which may include advertisements, will run. The displayed video pauses if and when the user click on any of the other clickable items. Whenever the video auto-pauses, a “Click to Continue” graphic is preferably displayed in the main media display 18.

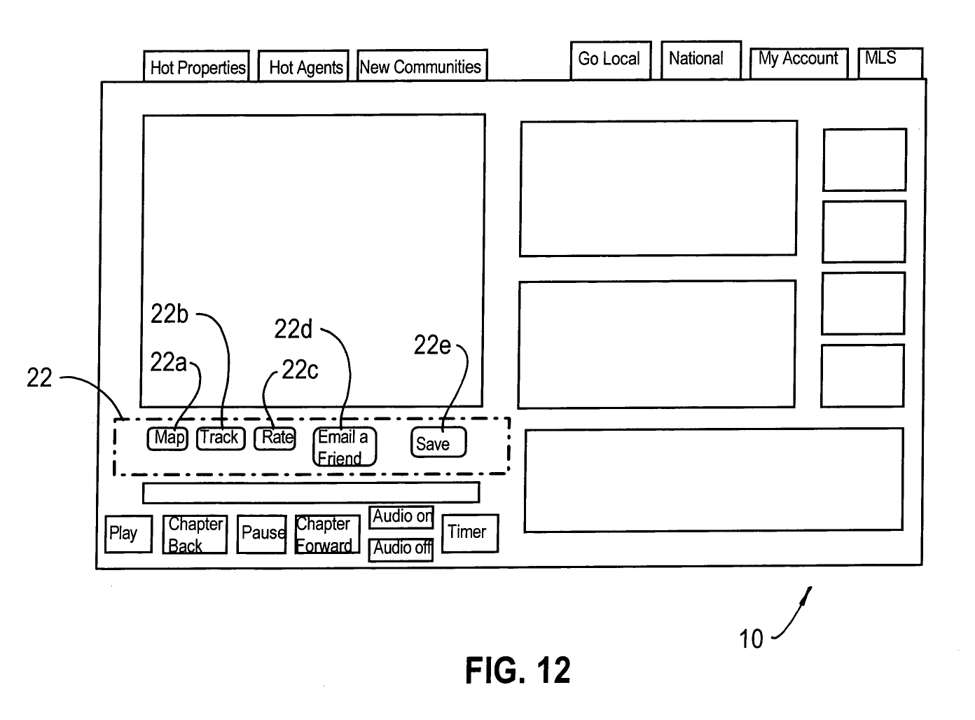

Referring to FIGS. 1 and 12: The Relationship/Feedback Buttons 22 can be employed by a user to obtain more information, provide feedback and/or save a link to the content shown in the main media display 18, by clicking on the corresponding button. Whenever the user rolls a cursor over an individual button 22a, 22b, 22c, 22d, 22e, a tool tip appears on the screen. When the user clicks on the respective button 22a, 22b, 22c, 22d, 22e the following activities are effected.

Clicking on the Map button 22a, causes the video that is being shown in the main media display 18 to be paused; and launches a pop up URL to a mapping service that shows the area of the property that is being shown in the main media display 18. The area that is to be shown in the map for each property will be managed in the Administration console.

Clicking on the Track button 22b, causes the video that is being shown in the main media display 18 to be paused; and opens a small screen (above the button), which provides the user with an opportunity to be contacted if there are any changes in the status and/or the price at which the respective property sells. The completed form is then emailed to the corresponding agent for the selected/displayed property. The data pertaining to the information that is gathered is sent to the System Provider's database.

Clicking on the Rate button 22c, causes the video that is being shown in the main media display 18 to be paused; and opens a small screen (above the button), which provides the user with an opportunity to rate the displayed property by choosing from among a list of pre-determined categories. The completed form is then emailed to the corresponding agent for the selected/displayed property. The data pertaining to the information that is gathered is sent to the System Provider's database.

Clicking on the “Email to a Friend” button 22d, causes the video that is being shown in the main media display 18 to be paused; and opens a small screen (above the button), which provides the user with an opportunity to send a friend an email with the link to the property that is currently being displayed. The completed form is then emailed to a friend at the identified email address. The data pertaining to the information that is gathered is sent to the System Provider's database.

Clicking on the “Save” button 22e opens a small screen (above the button), which provides the user with an opportunity to save a link to the property presentation to their own page for future reference. In order to accomplish this (i.e., save the link), the user will need to identify an existing account, or create an account. When the “Save” button 22e is clicked, the small screen displays a first field (titled, “Already have an account”) with a “Sign in!” prompt; and a second field (titled “Create an Account”) with “Your email”, “Password”, “Confirm password”, and other prompts.

The player control panel 40 for the main media display 18 is highlighted in FIG. 11. The player control panel 40 preferably comprises a Play Button 40a, Chapter Back Button 40b, Pause Button 40c, Chapter Forward Button 40d, Audio on/off buttons 40e, Player Timer 40f, and play head 40g for controlling the audio and video playback characteristics of the content presented in the main media display 18.

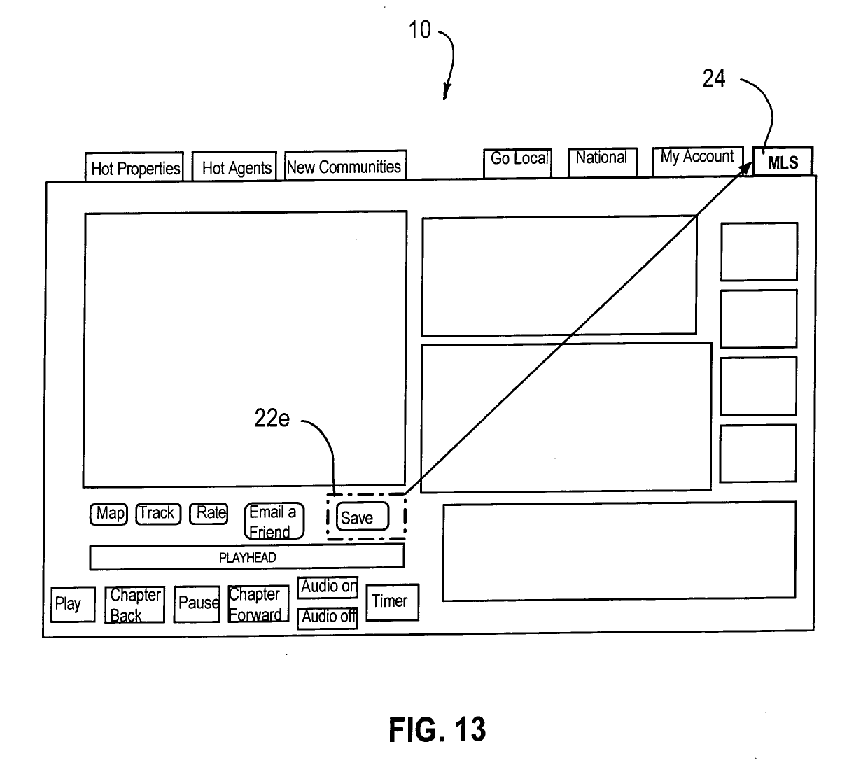

Referring to FIGS. 1 and 13: By clicking on the My Account tab 24, a user can open a new page that lists links that have been previously saved by the user under his/her account. This new page may be employed by the user to view previously saved video presentations in the main media display 18. The new page preferable includes a first field (titled, “Already have an account?”), with a “Sign in!” prompt; a second field (titled, “Create an account”) with “Your email”, “Password”, “Confirm Password”, and other prompts. For each saved property, a “title”, “description”, “link” (to the respective content), and “delete” field is provided.

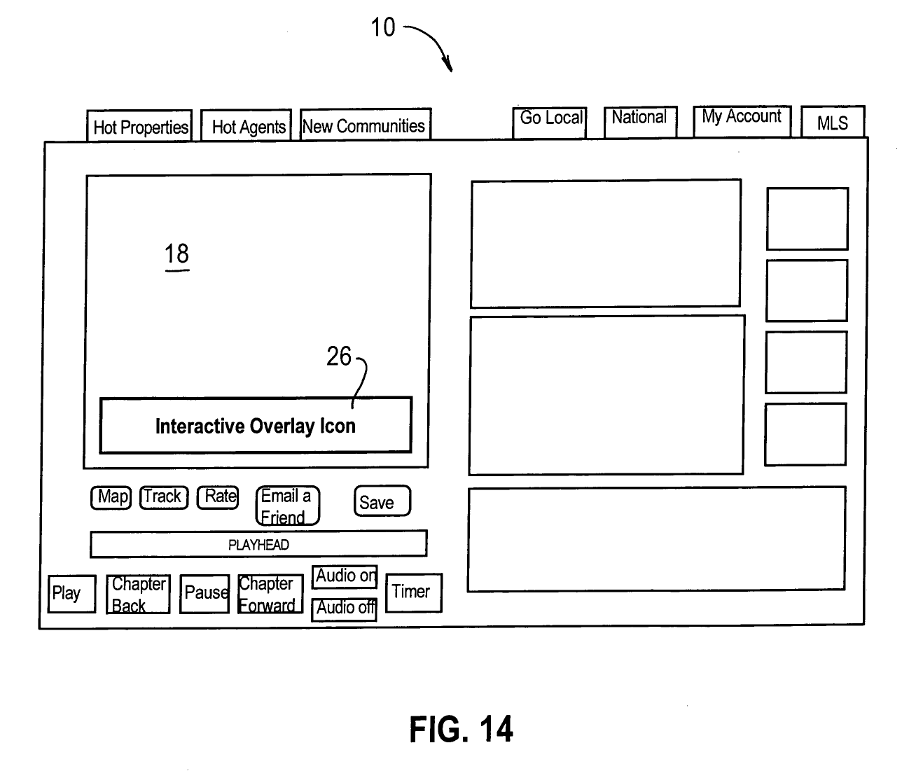

Referring to FIGS. 1 and 14: The interactive overlay icon 26 is located near the bottom of the main media display 18. Interactive overlay icon 26 can be placed on the main media display 18 while a video is playing, and is clickable by the user to initiate additional information.

The interactive overlay icon 26 is controlled by the administrative console. In the preferred embodiment of the invention, there is only one overlay icon 26 on the main media display 18 at a time. The administrative console controls Cue point when the icon is viewable, icon artwork that is displayed, location on the main media display where the icon is displayed, URL pop-up page that is activated when the icon is clicked, and enables the possibility to have the interactive overlay icon overlap over the main media display area.

Referring to FIG. 1: The MLS tab 34 is the gateway to the multiple listing service properties in the identified “local” area. When the user selects (i.e., “clicks on”) the MLS tab 34, a link is activated to a sponsoring agent's personal website, which personal website includes, among other things, a list of MLS properties in that agent's sales area. In the preferred embodiment of the invention, there are several sponsoring agents, and the particular personal website that the MLS button 34 is linked to at any time is based on a predetermined rotation schedule.

Player Behavior for First Time Visitor:

When a user visits the website for the first time, the following sequence typically occurs.

The player starts loading the respective files. Then a “Loading Message” appears in the main media display 18 area. Preferably, none of the clickable functionality will be active, until all of the appropriate files have been downloaded to the player. This is done to make sure that the user's experience is as seamless as possible.

Once all the files have been successfully loaded; then (a) an ad will play in the main display area 18; then a welcome message (audio and/or video) explaining what the System Provider has to offer starts playing automatically. During the welcome message, the user is prompted to “See a Demonstration” of how to use the player. If the user chooses to see the demonstration, it will slide out a new window (same as initiating an Ad Unit) and play. If the user does not choose to see the demonstration, then the first item in the playlist will automatically start to play.

Player Behavior for Repeat Visitor:

The sequence of operation is substantially the same for repeat visitors to the website as described above for first time visitors, except the first video does not automatically start to play, but waits for the user to initiate the action.

### Embodiment of Computer Execution Environment (Hardware)

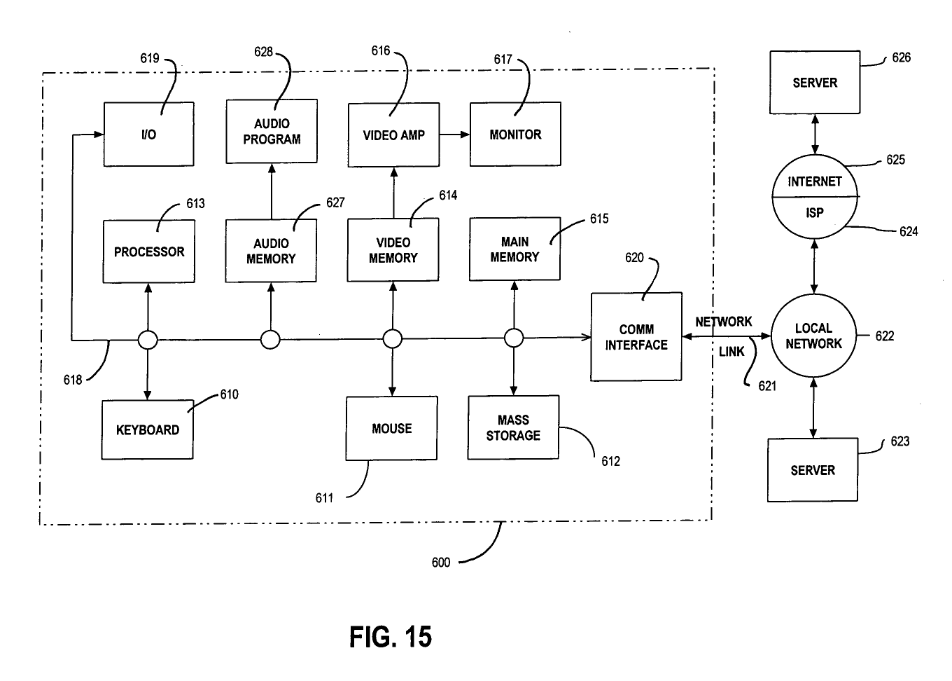

An embodiment of the invention can be implemented as computer software in the form of computer readable program code executed on one or more general-purpose computers such as the computer 600 illustrated in FIG. 15. A keyboard 610 and mouse 611 are coupled to a bi-directional system bus 618 (e.g., PCI, ISA or other similar architecture). The keyboard and mouse are for introducing user input to the computer system and communicating that user input to central processing unit (CPU) 613. Other suitable input devices may be used in addition to, or in place of, the mouse 611 and keyboard 610. I/O (input/output) unit 619 coupled to bi-directional system bus 618 represents possible output devices such as a printer or an A/V (audio/video) device.

Computer 600 includes video memory 614, main memory 615, mass storage 612, and communication interface 620. All these devices are coupled to a bi-directional system bus 618 along with keyboard 610, mouse 611 and CPU 613. The mass storage 612 may include both fixed and removable media, such as magnetic, optical or magnetic optical storage systems or any other available mass storage technology. The system bus 618 provides a means for addressing video memory 614 or main memory 615. The system bus 618 also provides a mechanism for the CPU to transferring data between and among the components, such as main memory 615, video memory 614 and mass storage 612.

In one embodiment of the invention, the CPU 613 is a microprocessor manufactured by Motorola, such as the 680X0 processor, an Intel Pentium III processor, or an UltraSparc processor from Sun Microsystems. However, any other suitable processor or computer may be utilized. Video memory 614 is a dual ported video random access memory. One port of the video memory 614 is coupled to video accelerator 616. The video accelerator device 616 is used to drive a CRT (cathode ray tube), and LCD (Liquid Crystal Display), or TFT (Thin-Film Transistor) monitor 617. The video accelerator 616 is well known in the art and may be implemented by any suitable apparatus. This circuitry converts pixel data stored in video memory 614 to a signal suitable for use by monitor 617. The monitor 617 is a type of monitor suitable for displaying graphic images.

The computer 600 may also include a communication interface 620 coupled to the system bus 618. The communication interface 620 provides a two-way data communication coupling via a network link 621 to a network 622. For example, if the communication interface 620 is a modem, the communication interface 620 provides a data communication connection to a corresponding type of telephone line, which comprises part of a network link 621. If the communication interface 620 is a Network Interface Card (NIC), communication interface 620 provides a data communication connection via a network link 621 to a compatible network. Physical network links can include Ethernet, wireless, fiber optic, and cable television type links. In any such implementation, communication interface 620 sends and receives electrical, electromagnetic or optical signals which carry digital data streams representing various types of information. The network link 621 typically provides data communication through one or more networks to other data devices. For example, network link 621 may provide a connection through local network 622 to a host computer 623 or to data equipment operated by an Internet Service Provider (ISP) 624. ISP 624 in turn provides data communication services through the world wide packet data 110 communication network now commonly referred to as the “Internet” 625. Local network 622 and Internet 625 both use electrical, electromagnetic or optical signals that carry digital data streams to files. The signals through the various networks and the signals on network link 621 and through communication interface 620, which carry the digital data to and from computer 600, are exemplary forms of carrier waves for transporting the digital information.

The computer 600 can send messages and receive data, including program code, through the network(s), network link 621, and communication interface 620. In the Internet example, server 626 might transmit a requested code for an application program through Internet 625, ISP 624, local network 622 and communication interface 620.

The computer systems described above are for purposes of example only. An embodiment of the invention may be implemented in any type of computer system or programming or processing environment. When a general-purpose computer system such as the one described executes the process and process flows described herein, it is configured to provide a mechanism for recommending a match to another is described.

Preferred Method of Operation of the Invention:

When connected to the Internet, a user can access the System by entering the platform's uniform resource locater (URL), which takes the user to the System's interface home page 10.

Preferably, when the home page GUI 10 is brought up (i.e., when the screen first appears), the ad unit display areas 14a and the key sponsor ad unit display area 14b are each populated with home page default advertisements; the main media display area 18 presents a default home page video (with accompanying audio); the main media adjacent content area presents a national default adjacent content image; and the playlist area for main media display presents a default home page playlist.

Multiple advertisements can be rotated, one at a time, in any of the ad unit display areas 14a, 14b. The particular advertisement to be displayed at any given time is controlled by the Site Administrator and may, for example, include content that is consistent with and relevant to the introductory, and typically national, nature of the content of the default home page video, the default adjacent content image, and the default home page playlist.

The default home page video (and accompanying audio) may, for example, welcome the user to the site and describe the site's features. The default adjacent content image may, for example, include a real estate Webcast link, and the default home page playlist may, for example, include links to archived Webcasts.

As used herein, the term “advertisement” refers to a sponsored message or image that is displayable on a computer screen, regardless of whether the message or image promotes any commercial product or service or whether the message or image offers anything for sale, rent or lease.

Whenever a user pulls up the home page GUI 10 and the default advertising material (i.e., in ad unit display areas 14a and the key sponsor ad unit display area 14b) is displayed, such activity, as well as the ISP location of the user's port/computer, are all automatically communicated to the Data Collection Site, where data are gathered that are indicative of how many times each default advertising image has been displayed, and indicative of the geographic region from which the site was accessed. The communication and storage of such data is invisible to the user, but is accessible to the system administrator.

The main media display 18, the main media adjacent content display 20, the playlist area 16 and the ad unit displays 14 are each clickable “hot spots. That is, the user may operate a mouse in order to position a cursor over the any of these clickable areas; and if the mouse is clicked while the cursor is so positioned, a new screen (or screen portion) will be pulled up, corresponding to the hypertext link in the background of the clicked-on “hot spot”. In the preferred embodiment of the invention, it is not necessary that the user log in (i.e., identify himself/herself) in order to access the home page or to activate any of the hot spots on the home page.

Whenever the user clicks on a “hot spot” on the home page, such activity is automatically communicated to the Data Collection Site, where data are gathered that are indicative of how many times each hot spot is clicked on. The communication and storage of such data is invisible to the user, but is accessible to the system administrator.

If, while on the home page 10, the user clicks on the “National” tab 30, the national page GUI 101 is brought up on the screen/monitor. Preferably, when the National page 101 is brought up (i.e., when the screen first appears), the ad unit display areas 14a and the key sponsor ad unit display area 14b are each populated with national page default advertisements; the main media display area 18 presents a default national page video (with accompanying audio); the main media adjacent content area presents a default national adjacent content image; and the playlist area for main media display presents a default national page playlist content image.

The default national page video (and accompanying audio) may, for example, welcome the user to the national real estate search site and describe the site's features. The default national adjacent content image may, for example, include a real estate Webcast link, and the default national page playlist may, for example, include a list of sponsored national real estate properties.

The particular advertisements to be displayed (i.e., in the ad unit display area 14) at any given time are controlled by the Site Administrator and may, for example, include content that is consistent with and relevant to the national nature of the content of the default national page video, the default national adjacent content image, and the default national page playlist.

The main media display 18, the main media adjacent content display 20, the playlist area 16 and the ad unit displays 14 are, as mentioned above, each clickable “hot spots. Whenever the user clicks on a “hot spot” from the national page, such activity is automatically communicated to the Data Collection Site, where data are gathered that are indicative of how many times each hot spot is clicked on. The communication and storage of such data is invisible to the user, but is accessible to the system administrator.

As mentioned above, the default national page playlist display area 16 may, for example, include a list of sponsored national real estate properties. Each playlist display item 160 preferably includes a photograph 16a and descriptive text 16b pertaining to an individual property. Each playlist display item 160 is a clickable hot spot.

If, while on the National page 101, the user clicks on an individual playlist display item 160, a sponsored property page GUI 102 is brought up on the screen/monitor. Preferably, when the Sponsored Property page 102 is brought up the ad unit display areas 14a and the key sponsor ad unit display area 14b are each populated with Targeted advertisements (as will be described in further detail below); the main media display area 18 presents a property-specific video (with accompanying audio); and the playlist area for main media display continues to present a list of sponsored national real estate properties. At the sponsored property page 102, the main media adjacent content area contains a Listing Agent display.

The Listing Agent display preferably comprises a photograph and textual description of the selected property's (i.e., that property which is being presented in the main media display's 18) sponsoring agent. In addition, the listing agent display area preferably comprises clickable “Contact Me”, “Video Profile”, “My Web Site” and “My Tours” buttons.

Clicking on the “Contact Me” button automatically sends an email notification of interest to the sponsoring agent. The notification will not be sent unless personal contact information pertaining to the user (such as name and email address) have been previously input to the “My Account” file. (See description of “My Account” tab 24, above.) If there is no contact information pertaining to the user in the file, the user will be prompted to click on the My Account tab 24.

Clicking on the “Video Profile” button causes a video (and accompanying audio) file of the sponsoring agent's profile to be displayed on the Main Media Display 18.

Clicking on the “My Web Site” button initiates a link to the sponsoring agent's (i.e., the listing agent for that property which is being presented in the main media display's 18) personal website.

When the “My Tours” button is clicked on, other real estate properties of the sponsoring agent are listed in the Playlist for Main Media Display area 16.

Whenever the user clicks on a playlist display item, the Sponsored Property page 102 corresponding to the selected display item is brought up to the screen.

As mentioned above, the main media display 18, the playlist area 16 and the ad unit displays 14, as well as the “Contact Me”, “Video Profile”, “My Website” and “My Tours” button within the main media adjacent content area, are each clickable “hot spots. Whenever the user clicks on any of these “hot spots” from the Sponsored Property page 102, such activity is automatically communicated to the Data Collection Site, where data are gathered that are indicative of how many times each hot spot is clicked on. The communication and storage of such data is invisible to the user, but is accessible to the system administrator

Referring again to FIG. 1 and the Home Page 10: If, while on the home page 10, the user clicks on the “Go Local” tab 28, a listing of localities that are represented by the System Provider is launched. Each listed locality is clickable. When the user clicks on a listed locality, the Local Page GUI 103 will be brought up to the screen.

Preferably, when the Local page 103 is brought up (i.e., when the screen first appears), the ad unit display areas 14a and the key sponsor ad unit display area 14b are each populated with Targeted advertisements (as will be described herein below); the main media display area 18 initially presents a default local “Hot Property” video (with accompanying audio); and the playlist area for main media display 16 presents a list of sponsored locality-specific real estate properties. At Local page 103, the main media adjacent content area 20 contains a Listing Agent Profile display corresponding to the sponsoring agent of the property that is currently being presented in the main media display 18.

As mentioned above, whenever the user clicks on a different playlist display 16 item (i.e., a listed property), the Sponsored Property page 102 corresponding to the selected playlist display item is brought up to the screen.

As described above with respect to the Sponsored Property page 102, when the user is at the Local Page 103, the main media display 18, the playlist area 16 and the ad unit displays 14, as well as the “Contact Me”, “Video Profile”, “My Website” and “My Tours” buttons within the main media adjacent content area, are each clickable “hot spots. Whenever the user clicks on any of these “hot spots” from the Local page 103, such activity is automatically communicated to the Data Collection Site, where data are gathered that are indicative of how many times each hot spot is clicked on. The communication and storage of such data is invisible to the user, but is accessible to the system administrator.

“Targeted Market Segment”, “Interested Users”, “Image Targeting Data”:

As has been previously mentioned, various data pertaining to a System user are preferably gathered and stored in the data collection site whenever a user accesses the system. As a minimum, whenever a user accesses the Home page 10, data indicative of the geographic location from which the site is being accessed, as well as identification of advertisements that are currently displayed in the various ad units display areas 14, are communicated to, and compiled by, the data collection site.

Furthermore, as has been previously described, whenever any “hot spot” is clicked on by the user, data indicative of such activity are communicated to, and compiled by, the data collection site.

It will be appreciated by those skilled in the art that the effectiveness of any particular advertisement is typically dependent on (among other things) (1) the number of times the advertisement is viewed, and (2) the degree to which the population that views the advertisement is representative of the market population for the advertised product or service.

By compiling data in the data collection site that are indicative of the identification of each displayed advertisement (for example, advertisements displayed in the ad unit display area 14), in combination with corresponding data indicative of the number of times each screen (for example, the home page 10, the National page 101, the sponsored property page 102 and local page 103) is accessed, it is possible for the described System to track (and, therefore, for the System Provider to charge a sponsor based on) the number of times each sponsored image (i.e., advertisement) is presented to a user.

Also, it may reasonably be expected that System users who click on a particular displayed advertisement (of, say, an advertised product, property or service) would, on average, be more likely to be interested in the advertised product, property or service, than would randomly selected System users. Accordingly, it may reasonably be expected that showing advertisements to such “interested users” would be of greater value to the advertiser than, for example, showing the advertisement to randomly selected System users. It will be appreciated that by compiling data in the data collection site that are indicative of the number of times particular individual displayed advertisements are clicked on by users, it is possible for the described System to track (and, therefore, for the System Provider to charge advertisers premium rates based on) the number of times each sponsored image is presented to such “interested users”.

As will be appreciated by those skilled in the advertising art, advertisements are typically directed at a targeted market segment. A “targeted market segment”, in this context, is a population of potential users of an advertised product or service. It is known to be desirable in the advertising trade to place advertisements for a product (or service) is front of individuals who have behavioral/cultural/social/economic/geographic/demographic characteristics that match or substantially correspond to characteristics of the advertised product's targeted market segment. The more closely those characteristics of an individual who views an advertised product matches the characteristics of the targeted market segment, the more effective (and, therefore, the more valuable) the advertisement is for the advertiser.

For each sponsored product (or service) that can be described or portrayed by an image that is to be displayed on any of the screens of the System (for example, the home page 10, the National page 101, the sponsored property page 102 and local page 103), product-specific (or service-specific) data (herein referred to as “image targeting data”) descriptive of the behavioral/cultural/social/economic/geographic/demographic characteristics of the targeted market segment for that product (or service) is input into, and stored in, the System's main memory 615.

As has been previously mentioned, various data pertaining to a System user are preferably gathered and stored in the data collection site whenever a user accesses the system. Also, as has been previously described, whenever any “hot spot” is clicked on by the user, data indicative of such activity are communicated to, and compiled by, the data collection site. Also, as has been previously described, at certain System dialog boxes (for example, after clicking on the “My Account” tab (24)), the System user can directly input information about himself to the data collection site. By compiling and storing, for each System user, all such data, a broad “user profile” of each user can be determined and stored.

Furthermore, by comparing cross-field data for a System user, from multiple characteristic disciplines, a narrower user profile for a System user can be determined and stored. From among data entry fields of behavioral, cultural, social, economic and geographic, and demographic characteristics about a System user, certain cross-field pointers can be identified; and such cross-field pointers can be processed (e.g., by the processor 613) to generate a somewhat narrower user profile.

By way of example, user characteristic data in, say, the fields of economics and geography are known for a particular System user. Based on such data (economic field data and geographic field data), certain economic field and geographic field “pointers” about the user may be determined. Such economic field and geographic field pointers can be used by the (processor 613 of the) System to determine other-field characteristics about the user's profile. For example, if the economic field data stored in the System indicates that the System user has a history of searching for properties in a certain price range, an economic field pointer for the user might be “high price search range”. If the geographic field data stored in the System indicates, for example, that the System user also has a history of searching for properties of a certain geographic characteristic, a geographic field pointer for the user might be “deep water property search range”. Based on these two (geographic and economic field) pointers, a broad user profile including characteristics of the two (geographic and economic) fields can be determined. Such a broad user profile might be that the user has an interest in expensive properties and properties adjacent to water. In addition, based on these two (geographic and economic field) pointers, a narrower user profile, including cross-field or other-field characteristics can be calculated. For the example used, such a narrower user profile might include, not only that the user has an interest in expensive properties and properties adjacent to water, but that the user also may have an interest in recreational boating. Thus, in the example used, the two (geographic and economic) field pointers can be used to determine a third (behavioral) field characteristic about the user.

It will be appreciated by those skilled in the art that in the above described manner that, from among data entry fields of behavioral, cultural, social, economic and geographic, and demographic characteristics about a System user, certain cross-field pointers can be identified; and such cross-field pointers can be processed (e.g., by the processor 613) to generate a somewhat narrower user profile.

It will also be understood by those skilled in the art that as additional behavioral, cultural, social, economic and geographic, and demographic characteristics about a user are entered into the System, additional “pointers” about the user can be identified, and, accordingly, a more narrow and more accurate user profile can be determined for the user.

When a user profile is determined for a System user, the (processor 613 of the) System compares profile pointers for that user with the “image targeting data” for various sponsored products and services that are stored in the Systems main memory 615. If there is a match (or matches) between the user profile pointers of the System user and the image targeting data for a particular sponsored product (or service), that particular System user may be reasonably expected to be in the “targeted market segment” for that particular sponsored product (or service). When (the processor 613 determines that) there is a match (or matches) between the user profile pointers of the System user and the image targeting data for a particular sponsored product (or service), images of that particular sponsored product (or service) is displayed on the screen.

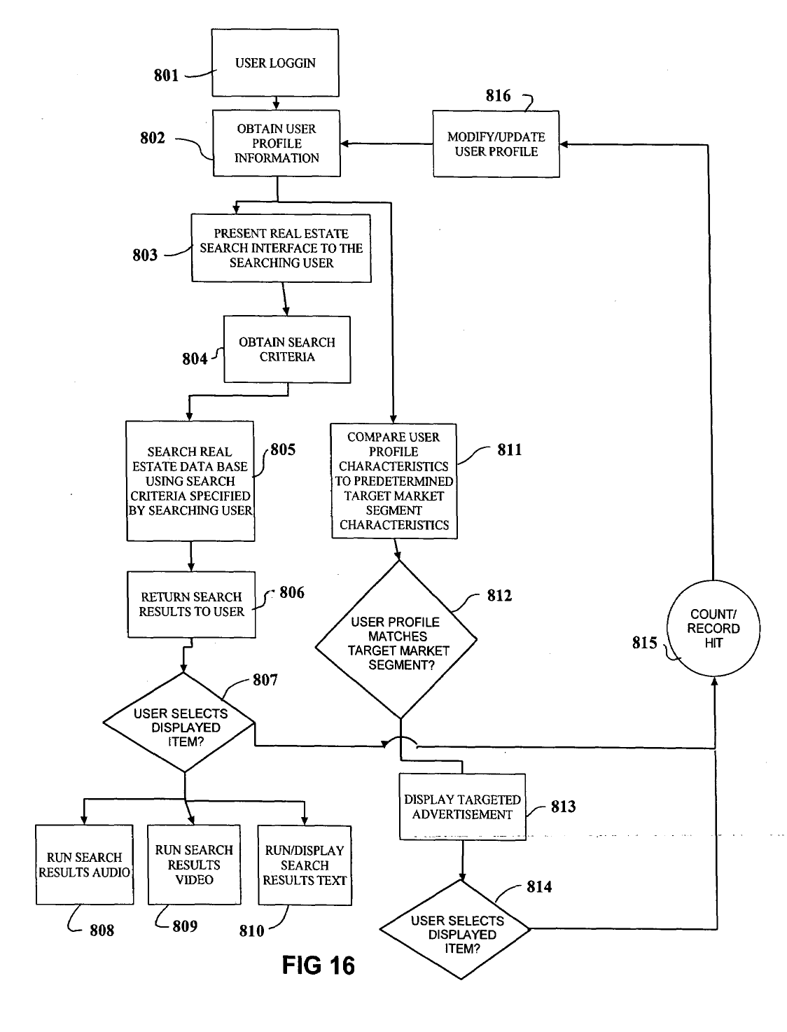

FIG. 16 summarizes the steps of the preferred method of practicing the present invention. A user logs in 801 and the users profile information is obtained 802. The user is presented with a real estate search interface 803. The user inputs search criteria 804 to the computer, and the computer searches 805 the real estate data base for real estate having characteristics matching the search criteria. The search results are returned to the user 806, typically in the form of a listing of properties. The user selects a displayed property 807, and the computer runs coordinated audio 808, video 809 and/or text 810 messages describing the selected property. The selection 807 of the property is counted and recorded 815, and the user profile is updated/modified 816 in accordance with predetermined characteristics of the selected property.

After a user is logged 801 onto the system, the user's profile characteristics are compared to predetermined target market segment characteristics 812. When the user profile characteristics match 812 predetermined target market segment characteristics, a targeted advertisement is displayed 813. If the user selects (i.e., “clicks on”) 814 a displayed targeted advertisement, the user's 814 of that advertisement is counted and recorded 815, and the user profile is updated/modified 816 in accordance with predetermined characteristics of the selected targeted advertisement.

It will be understood from the above description that the present invention provides means for delivering sponsored advertisements to System users who can be reasonably determined to be among the target market segment for such advertisements. In addition, it will be understood from the above description that the present invention provides means for tracking the number of times (and, therefore, means by which the System Provider can charge an advertiser for) delivering targeted advertisements to System users in the targeted market segment.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

I claim:

1. An internet-based real estate searching process, comprising the steps of:
obtaining user profile information;
presenting a real estate search interface to a searching user;
obtaining search criteria from the searching user;
searching a real estate data base using said search criteria;
returning search results;
obtaining a property selection from among said search results; and,
running coordinated video and audio information relevant to said property selection.

2. The process according to claim 1, further comprising the step of:
after said step of obtaining a property selection, modifying a total count of the number of times said property selection is selected.

3. The process according to claim 2, further comprising the step of:
after said step of obtaining a property selection, modifying said user profile information in accordance with predetermined characteristics of said property selection.

4. The process according to claim 3, further comprising the steps of:
comparing said user profile information to predetermined target market segment characteristics; and,
displaying a targeted advertisement corresponding to said target market segment characteristics; and,
modifying a total count of the number of times said targeted advertisement is displayed.

5. The process according to claim 4, further comprising the steps of:
obtaining a targeted advertisement selection; and,
after said step of obtaining a targeted advertisement selection, modifying a total count of the number of times said targeted advertisement is selected.
